(19) United States
(12) Patent Application Publication
(10) Pub. No.: US 2015/0168750 A1
(43) Pub. Date: Jun. 18, 2015

(54) LIQUID CRYSTAL ALIGNMENT DEVICE

(71) Applicant: Shenzhen China Star Optoelectronics Technology Co., Ltd., Shenzhen (CN)

(72) Inventors: Shengpeng Mo, Shenzhen (CN); Chonghui Yin, Shenzhen (CN); Wen-ping Chiang, Shenzhen (CN)

(21) Appl. No.: 13/701,522

(22) PCT Filed: Aug. 29, 2012
(86) PCT No.: PCT/CN12/80687

§ 371 Date: Dec. 3, 2012

(30) Foreign Application Priority Data
Aug. 20, 2012 (CN) 201220413758.4

(51) Int. Cl. G02F 1/13; G02F 1/1337

(52) U.S. Cl. CPC G02F 1/1303; G02F 1/133788

(57) ABSTRACT

The present invention proposes a liquid crystal alignment device and the liquid crystal alignment device comprises light sources, a light emitting plate and reflective plates, and the light sources are disposed on the light emitting plate; the reflective plate is disposed on a side surface of the light sources, and a reflective surface of each of the reflective plates is facing the light sources; the reflective surface of the reflective plate appears to be a rough shape. Therefore, even if the UV rays emitted by the light source are not uniform, the evenness of the UV rays transmitted to the liquid crystal layer can be ensured after the reflection of the reflective plate, and thereby avoid the Mura occurring during the alignment process. The product yield is increased and the display result of the LCD is guaranteed.

### FIELD OF THE INVENTION

The present invention relates to a field of liquid crystal manufacturing technique, and more particularly relates to a liquid crystal alignment device.

### BACKGROUND OF THE INVENTION

A Liquid Crystal Display (LCD) is widely used in many different kinds of electronic devices. Most of the LCDs are backlight LCDs and the backlight LCD comprises an LCD panel and a backlight module. The LCD panel comprises two transparent substrates and liquid crystals sealed therebetween.

Currently, a Vertical. Alignment (VA) technique is developed for the LCD panel. For example, a Polymer Stabilized Vertical Alignment (PSVA) LCD, which is made by a polymer-stabilized alignment (PSA) process, has many advantages, such as a wide view angle, a high aperture ratio, a high contrast, a simple manufacturing process and so on.

In the PSVA LCD, a liquid crystal layer which is provided between two transparent substrates is filled with negative liquid crystal molecules, and reactive monomers are mixed therein. The reactive monomers are mixed with the negative liquid crystal molecules. The surface of each of the transparent substrates is coated with polyimide (PT) as an alignment material. Then, when the two transparent substrates are applied with a voltage and irradiated by an Ultraviolet (UV) ray, a phase separation phenomenon may occur between the reactive monomers and the liquid crystal molecules, and polymers are generated on the alignment material of the transparent substrates. Because of the mutual action between the polymers and the liquid crystal molecules, the liquid crystal molecules are arranged along the direction of the polymer molecules. Therefore, the liquid crystals between the transparent substrates possess a pre-tilt angle.

In order to ensure that the pre-tilt angle of the liquid crystal molecules is formed by the irradiation of the UV ray without generating a color unevenness (also called “Mura”), the evenness of the irradiation of the UV ray must be strictly controlled. Generally, the evenness of the irradiation of the UV ray is required to be about 10%.

Please refer to FIG. 1, FIG. 1 is a cross-sectional view which illustrates a UV ray irradiation device in the prior art.

The UV ray irradiation alignment device includes a light source plate 11 at the top, and the light source plate 11 includes elongated lighting tubes 111 which are utilized to irradiate UV ray. Reflective plates 12 are disposed on four sides of the light source plate 11. Each of the reflective plates 12 has an installation angle with respect to the light source plate 11, and the installation angle is fixed and not adjustable. Each of the reflective plates 12 also includes a top side plate 121 and a bottom side plate 122, and internal surfaces of the top side plate 121 and the bottom side plate 122 are flat. The UV ray is reflected by the top side plate 121 and the bottom side plate 122 to form a horizontal ray, as shown in FIG. 2.

As the service time of the light bulbs 111 is increased, the luminance at two ends of the lighting tubes 111 is gradually decreased. As a result, a middle portion of the lighting tube 111 has a higher luminance, but two ends of the lighting tube 111 have a lower luminance. The unevenness problem still cannot be resolved, even the light is reflected by the reflective plates 12 after being emitted from the lighting tube 111. Therefore, the liquid crystal molecules are irradiated with different evenness, and accordingly the Mura is generated after the liquid crystal molecules are aligned.

Therefore, the technical problem described above which exists in current technology needs to be resolved.

### SUMMARY OF THE INVENTION

The present invention is to provide a liquid crystal alignment device to resolve the technique problem that the unevenness (Mora) of the aligned liquid crystal molecules which is caused by the uneven levels of the light transmitted to the liquid crystals during the alignment process.

The main object of the present invention is to propose a liquid crystal alignment device which comprises light sources, a light emitting plate and reflective plates, and the light sources are disposed on the light emitting plate.

The reflective plate is disposed on a side surface of the light sources, and a reflective surface of the reflective plate is facing the light sources; the reflective surface of the reflective plate appears to be a rough shape.

In one embodiment of the present invention, the light emitting plate includes two long sides opposite to each other, and two short sides opposite to each other; each of the light sources is an elongated shape and the light sources are horizontal to the long side surface of the light emitting plate and disposed with an equal interval therebetween.

In one embodiment of the present invention, a rotating device is disposed between the reflective plate and the light emitting plate, and the reflective plate and the light emitting plate are rotatably connected to the rotating device.

In one embodiment of the present invention, the rotating device includes a first rotating shaft and a first rotating drum, and the first rotating shaft is firmly disposed on the light emitting plate and the first rotating drum is firmly disposed on the reflective plate; wherein the first rotating drum is a hollowed structure and the first rotating shaft penetrates through the first rotating drum, the reflective plate is rotatable with respect to the light emitting plate.

In one embodiment of the present invention, the reflective plate includes a first reflective plate and a second reflective plate, and a rolling device is disposed between the first reflective plate and the second reflective plate, the first reflective plate and the second reflective plate of each of the reflective plate are connected by the rolling device.

In one embodiment of the present invention, the rolling device includes a second rotating shaft and a second rotating drum, and the second rotating shaft is disposed on the first reflective plate and the second rotating drum is disposed on the second reflective plate, wherein the second rotating drum is a hollowed structure and the second rotating shaft penetrates through the second rotating drum, so that the first reflective plate is rotatable with respect to the second reflective plate.

In one embodiment of the present invention, the reflective plate includes a long reflective plate connected to the long side surface of the light emitting plate and a short reflective plate connected to the short side surface of the light emitting plate, and the rotating device includes a first rotating device and a second rotating device; the long reflective plate is connected to the light emitting plate by the first rotating device and the short reflective plate is connected to the light emitting plate by the second rotating device.

In one embodiment of the present invention, the long reflective plate includes a first long reflective plate connected to the light emitting plate and a second long reflective plate connected to the first long reflective plate; the rolling device includes a first rolling device, and the first long reflective plate and the second reflective plate are rotatably connected by the first rolling device.

In one embodiment of the present invention, the short reflective plate includes a first short reflective plate connected to the light emitting plate and a second short reflective plate connected to the first short reflective plate, and the rolling device further includes a second rolling device; the first short reflective plate is rotatably connected to the second short reflective plate by the second rolling device.

Another object of the present invention is to provide a liquid crystal alignment device and the liquid crystal alignment device comprises light sources and a reflective plate, and a reflective surface of the reflective plate appears to be a rough shape.

In one embodiment of the present invention, the reflective plate is disposed on a side surface of the light sources; the reflective surface of the reflective plate is facing the light sources.

In one embodiment of the present invention, the liquid crystal alignment device further includes a light emitting plate, and the light sources are disposed on the light emitting plate and the light emitting plate includes two long sides opposite to each other, and two short sides opposite to each other; each of the light sources is an elongated shape and the light sources are horizontal to the long side surface of the light emitting plate and disposed with an equal interval therebetween.

In one embodiment of the present invention, a rotating device is disposed between the reflective plate and the light emitting plate, and the reflective plate and the light emitting plate are rotatably connected by the rotating device.

In one embodiment of the present invention, the rotating device includes a first rotating shaft and a first rotating drum, and the first rotating shaft is firmly disposed on the light emitting plate and the first rotating drum is firmly disposed on the reflective plate; wherein the first rotating drum is a hollowed structure and the first rotating shaft penetrates through the first rotating drum, the reflective plate is rotatable with respect to the light emitting plate.

In one embodiment of the present invention, the reflective plate includes a first reflective plate and a second reflective plate, and a rolling device is disposed between the first reflective plate and the second reflective plate, the first reflective plate and the second reflective plate of each of the reflective plate are connected by the rolling device.

In one embodiment of the present invention, the rolling device includes a second rotating shaft and a second rotating drum, and the second rotating shaft is disposed on the first reflective plate and the second rotating drum is disposed on the second reflective plate, wherein the second rotating drum is a hollowed structure and the second rotating shaft penetrates through the second rotating drum, so that the first reflective plate is rotatable with respect to the second reflective plate.

In one embodiment of the present invention, the reflective plate includes a long reflective plate connected to the long side surface of the light emitting plate and a short reflective plate connected to the short side surface of the light emitting plate, and the rotating device includes a first rotating device and a second rotating device; the long reflective plate is connected to the light emitting plate by the first rotating device and the short reflective plate is connected to the light emitting plate by the second rotating device.

In one embodiment of the present invention, the long reflective plate includes a first long reflective plate connected to the light emitting plate and a second long reflective plate connected to the first long reflective plate; the rolling device includes a first rolling device and the first long reflective plate and the second reflective plate are rotatably connected by the first rolling device.

In one embodiment of the present invention, the short reflective plate includes a first short reflective plate connected to the light emitting plate and a second short reflective plate connected to the first short reflective plate, and the rolling device further includes a second rolling device; the first short reflective plate is rotatably connected to the second short reflective plate by the second rolling device.

The above-mentioned description of the present invention can be best understood by referring to the following detailed description of the preferred embodiments and the accompanying drawings.

### DESCRIPTION OF THE DRAWINGS

FIG. 1 is a cross-sectional view illustrating an ultraviolet (UV) ray irradiation device in the present technique;

FIG. 2 is a schematic structural view illustrating the reflective plate of the UV ray irradiation device in FIG. 1;

FIG. 3 is a structural schematic top view illustrating a liquid crystal alignment device provided in a preferred embodiment of the present invention;

FIG. 4 is a structural schematic view illustrating an internal surface of the liquid crystal alignment device in FIG. 3;

FIG. 5 is a cross-sectional structural view taken along an A-A′ line in FIG. 3;

FIG. 6 is a cross-sectional structural view taken along a B-B′ line in FIG. 3;

FIG. 7 is an explored structural view illustrating the first rotating device in FIG. 5;

FIG. 8 is an explored structural view illustrating the second rotating device in FIG. 5; and

FIG. 9 is a transmitting path view illustrating the light on the reflective surface of the first long reflective plate.

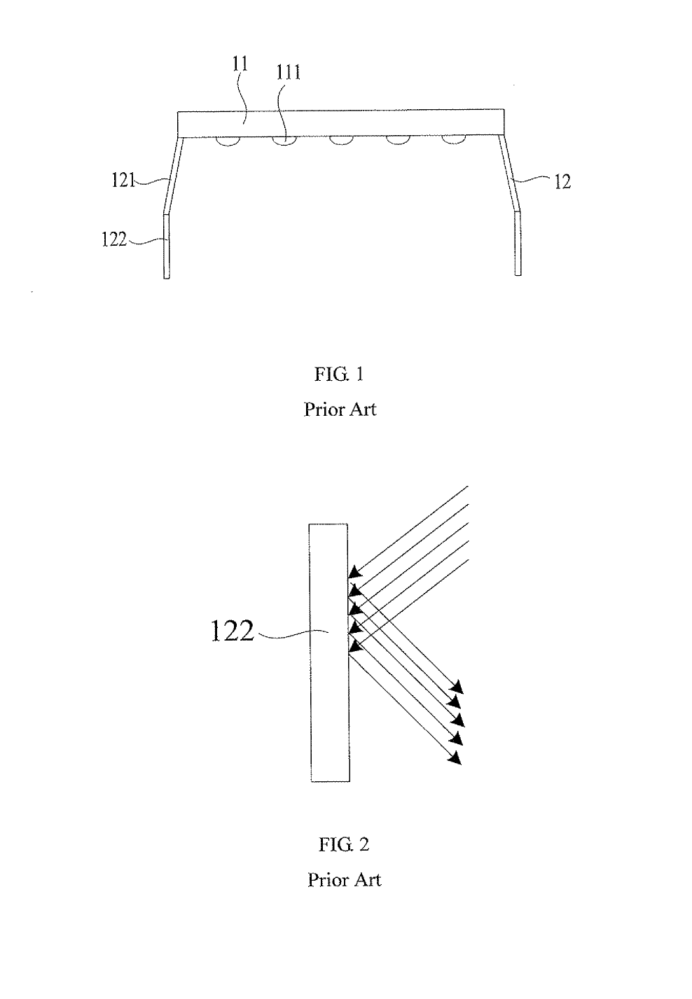

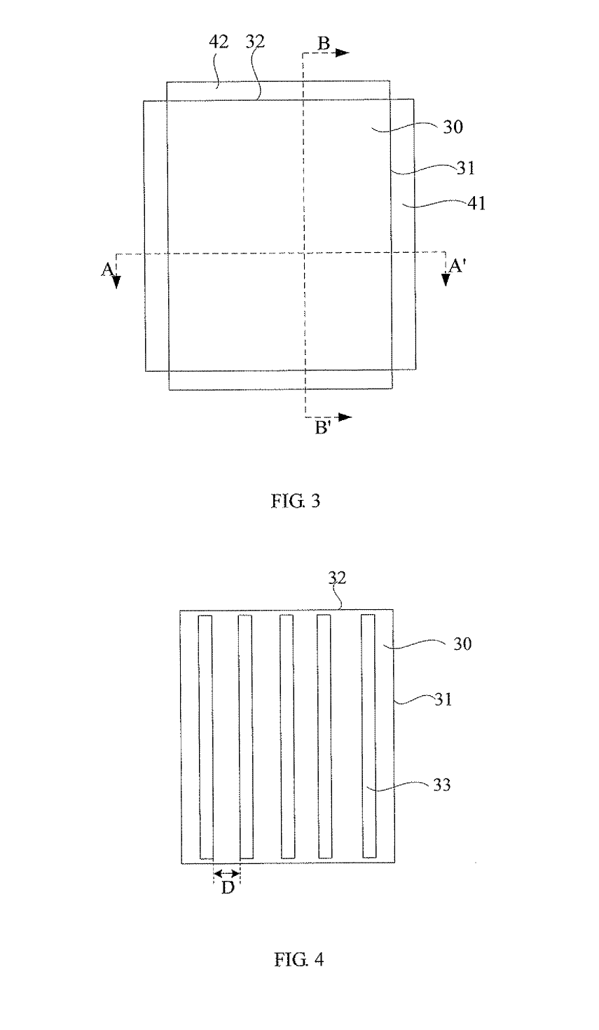

### DETAILED DESCRIPTION OF THE PREFERRED EMBODIMENTS

In the following detailed description of the preferred embodiments, reference is made to the accompanying drawings which form a part hereof, and as shown by way of illustration specific embodiments in which the invention may be practiced. In this regard, directional terminology, such as “top,” “bottom,” “front,” “back,” “left,” “right,” “inside,” “outside,” “side,” etc., is used with reference to the orientation of the Figure(s) being described. As such, the directional terminology is used for purposes of illustration and is in no way limiting the present invention.

Please refer to FIG. 3, FIG. 3 is a structural schematic top view illustrating a liquid crystal alignment device provided in a preferred embodiment of the present invention.

The liquid crystal alignment device includes a light emitting plate 30, and the light emitting plate 30 includes long sides 31 arranged in parallel and short sides 32 arranged in parallel. The liquid crystal alignment device further includes reflective plates, and the reflective plates include long reflective plates 41 and short reflective plates 42. Each long reflective plate 41 is connected to the long side 31 of the light emitting plate 30 and each short reflective plate 42 is connected to the short side 32 of the light emitting plate 30.

Please refer to FIG. 4, FIG. 4 is a structural schematic view which illustrates the light emitting plate 30. The light emitting plate 30 includes a plurality of light sources 33, each of the light sources 33 is an elongated shape and is utilized to emit Ultraviolet (UV) ray. The light source 33 is disposed to parallel with the long side 31 of the light emitting plate 30. The light sources 33 are evenly arranged with an interval D therebetween. The interval D is within a predetermined distant range and the predetermined distant range is preferred to be 200-220 mm.

In other embodiments, the two long sides 32 of the light emitting plate 30 are not arranged in parallel, as well as the two short side surfaces 33 are not arranged in parallel. The above-mentioned are included in the scope of the present invention, and the detailed description thereof is omitted herein.

Please refer to FIG. 5, FIG. 5 is a cross-sectional structural view taken along an A-A′ line in FIG. 3. The long reflective plate 41 includes a first long reflective plate 411 and a second long reflective plate 412. There is a first rotating device 51 disposed between the first long reflective plate 411 and the light emitting plate 30. The first long reflective plate 411 is connected to the light emitting plate 30 by the first rotating device 51. The first long reflective plate 411 is rotatable with respect to the light emitting plate 30. A first rolling device 61 is disposed between the first long reflective plate 411 and the second long reflective plate 412. The second long reflective plate 412 is connected to the first long reflective plate 411 by the first rolling device 61 and is rotatable with respect to the first long reflective plate 411.

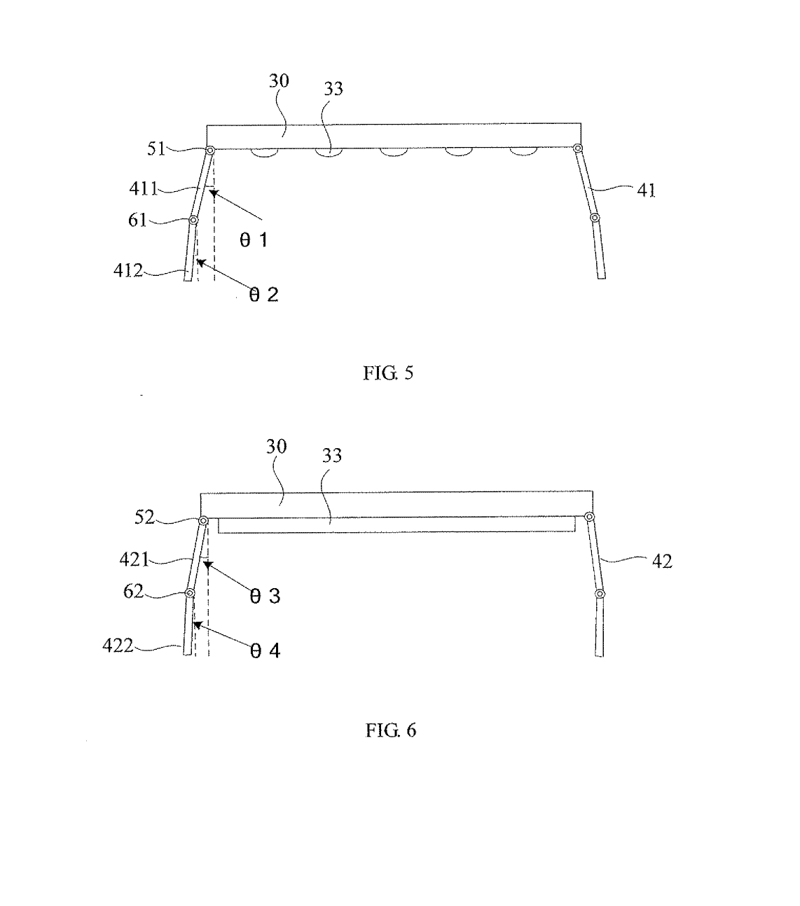

Please refer to FIG. 6, FIG. 6 is a cross-sectional structural view taken along a B-B′ line in FIG. 3. The short reflective plate 42 includes a first short reflective plate 421 and a second short reflective plate 422. A second rotating device 52 is disposed between the first short reflective plate 421 and the light emitting plate 30. The first short reflective plate 421 is connected to the light emitting plate 30 by the second rotating device 52 and is rotatable with respect to the light emitting plate 30. A second rolling device 62 is disposed between the first short reflective plate 421 and the second short reflective plate 422. The second short reflective plate 422 is connected to the first short reflective plate 421 by the second rolling device 62 and is rotatable with respect to the first short reflective plate 421.

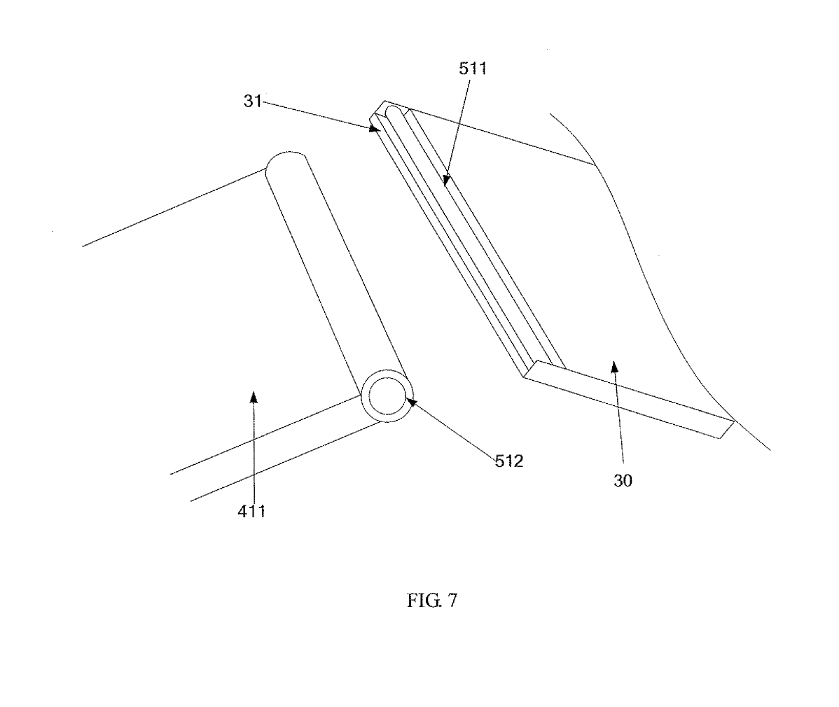

Please refer to FIG. 7, FIG. 7 is an explored view which illustrates the first rotating device 51 in FIG. 5. The light emitting plate 30 includes a first rotating shaft 511 and a first rotating drum 512 disposed at the first long reflective plate 411 accordingly. The first rotating drum 512 is a hollowed structure and the first rotating shaft 511 can penetrate through the first rotating drum 512. The first rotating shaft 511 is rotatable with respect to the first rotating drum 512, so that the first long reflective plate 411 is rotatable with respect to the light emitting plate 30. Because the structure of the second rotating device 52 is the same as the first rotating device 51, the detailed description thereof is omitted herein.

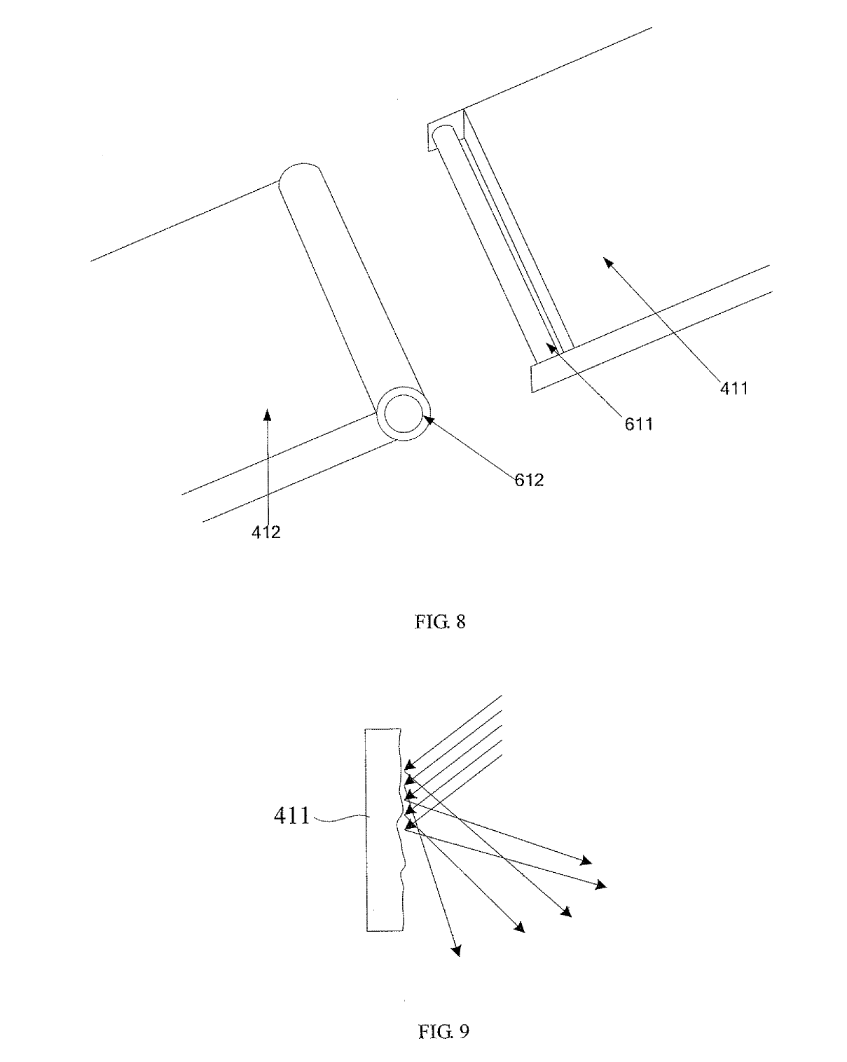

Please refer to FIG. 8, FIG. 8 is an explored view which illustrates the first rolling device 61 in FIG. 5. The first long reflective plate 411 includes a second rotating shaft 611 and a second rotating drum 612 disposed at the second long reflective plate 412 accordingly. The second rotating drum 612 is a hollowed structure. The second rotating shaft 611 can penetrate through the second rotating drum 612 and the second rotating shaft 611 is rotatable with respect to the second rotating drum 612, so that the second long reflective plate 412 is rotatable with respect to the first long reflective plate 411. The structure of the second rolling device 62 is the same as the first rolling device 61 and the detail description thereof is omitted herein.

Most of the UV rays emitted from the light source 33 irritate on the liquid crystal layer (not shown) and the rest of the UV rays irradiate on the reflective plate. The UV ray transmitted to the reflective plate is reflected by an internal surface of the reflective plate then enters the liquid crystal layer.

In the present invention, the reflective surface of the reflective plate is rough and not a flat surface. The reflective surface of the first long reflective plate 411 will be described for example. Please refer to FIG. 9, FIG. 9 is a schematic view showing a transmitting path through which the light goes via the reflective surface of the first long reflective plate 411. The reflective surface of the first long reflective plate 411 is rough and the light emitted by the light source 33 is reflected by the reflective surface of the first long reflective plate 411 to scatter in many different directions.

Because the reflective surface of the reflective plate in the present invention is rough, after the UV ray transmitted to the reflective plate is reflected by the reflective plate, the progressing paths are dispersed to create a diffuse reflection. Therefore, even if the UV rays emitted by the light source are not uniform, the evenness of the UV rays transmitted to the liquid crystal layer can be ensured after the reflection of the reflective plate, and thereby avoid the Mura occurring during the alignment process. The product yield is increased and the display result of the LCD is guaranteed.

Please refer to FIG. 5 as well. The first rotating device 51 is disposed between the first long reflective plate 411 and the light emitting plate 30, and the first long reflective plate 411 is rotatable with respect to the light emitting plate 30 by disposing the first rotating device 51. Therefore, an included angle θ1 between the normal line (a line vertical to the transmitting line of the light emitting plate) of the light emitting plate 30 and the first long reflective plate 411 can be flexibly adjusted. Because the first rolling device 61 is disposed between the second long reflective plate 412 and the first long reflective plate 411, the second long reflective plate 412 is rotatable with respect to the first long reflective plate 411 by the first rolling device 61. Therefore, an included angle θ2 between the first long reflective plate 411 and the normal line of the light emitting plate 30 can be flexibly adjusted in the present invention.

Similarity, in FIG. 6, an included angle θ3 between the first short reflective plate 421 and the light emitting plate 30 and an included angle θ4 between the second short reflective plate 422 and the normal line of the second short reflective plate 422 can be flexibly adjusted. Obviously, the included angle between the reflective plate and the normal line of the light emitting plate is adjusted in the present invention to control the UV rays reflected to the liquid crystal layer so as to even the UV rays irradiating on the liquid crystal layer. The Mura can be avoided during the alignment process and the product yield can be increased.

The reflective surface of the reflective plate in the present invention is designed to be rough, and the light transmitted to the reflective plate is reflected by the reflective surface to scatter to the liquid crystal layer. Therefore, it is guaranteed that the light irradiated to the liquid crystal layer is even to avoid the Mura after the alignment process and increase the product yield.

As described above, the present invention has been described with preferred embodiments thereof and it is understood that many changes and modifications to the described embodiments can be carried out without departing from the scope and the spirit of the invention that is intended to be limited only by the appended claims.

What is claimed is:

1. A liquid crystal alignment device, wherein the LC alignment device comprises light sources, a light emitting plate and reflective plates, and the light sources are disposed on the light emitting plate;
each of the reflective plates is disposed on a side of the light sources, and a reflective surface of the reflective plate is facing the light sources; the reflective surface of the reflective plate appears to be a rough shape

2. The liquid crystal alignment device according to claim 1, wherein the light emitting plate comprises two long sides opposite to each other and two short sides opposite to each other; each of the light sources is an elongated shape and the light sources are parallel to the long side of the light emitting plate and disposed with an equal interval therebetween.

3. The liquid crystal alignment device according to claim 2, wherein a rotating device is disposed between the reflective plate and the light emitting plate, and the reflective plate and the light emitting plate are rotatably connected by the rotating device.

4. The liquid crystal alignment device according to claim 3, wherein the rotating device comprises a first rotating shaft and a first rotating drum, and the first rotating shaft is firmly disposed on the light emitting plate and the first rotating drum is firmly disposed on the reflective plate; wherein the first rotating drum is a hollowed structure and the first rotating shaft penetrates through the first rotating drum, the reflective plate is rotatable with respect to the light emitting plate.

5. The liquid crystal alignment device according to claim 4, wherein each of the reflective plates comprises a first reflective plate and a second reflective plate, and a rolling device is disposed between the first reflective plate and the second reflective plate, the first reflective plate and the second reflective plate of each of the reflective plates are rotatably connected by the rolling device.

6. The liquid crystal alignment device according to claim 5, wherein the rolling device comprises a second rotating shaft and a second rotating drum, and the second rotating shaft is disposed on the first reflective plate and the second rotating drum is disposed on the second reflective plate, wherein the second rotating drum is a hollowed structure and the second rotating shaft penetrates through the second rotating drum, the first reflective plate is rotatable with respect to the second reflective plate.

7. The liquid crystal alignment device according to claim 5, wherein the reflective plates comprise a long reflective plate connected to the long side of the light emitting plate and a short reflective plate connected to the short side of the light emitting plate, and the rotating device comprises a first rotating device and a second rotating device; the long reflective plate is connected to the light emitting plate by the first rotating device and the short reflective plate is connected to the light emitting plate by the second rotating device.

8. The liquid crystal alignment device according to claim 7, wherein the long reflective plate comprises a first long reflective plate connected to the light emitting plate and a second long reflective plate connected to the first long reflective plate, the rolling device comprises a first rolling device, and the first long reflective plate and the second reflective plate are rotatably connected by the first rolling device.

9. The liquid crystal alignment device according to claim 7, wherein the short reflective plate comprises a first short reflective plate connected to the light emitting plate and a second short reflective plate connected to the first short reflective plate, and the rolling device further comprises a second rolling device, the first short reflective plate is rotatably connected to the second short reflective plate by the second rolling device.

10. A liquid crystal alignment device comprising light sources and reflective plates, and a reflective surface of each of the reflective plates appears to be a rough shape.

11. The liquid crystal alignment device according to claim 10, wherein the reflective plate is disposed on a side surface of the light sources; the reflective surface of the reflective plate is facing the light sources.

12. The liquid crystal alignment device according to claim 10, wherein the liquid crystal alignment device further comprises a light emitting plate, and the light sources are disposed on the light emitting plate, the light emitting plate comprises two long sides opposite to each other and two short side surfaces opposite to each other; each of the light sources is an elongated shape and the light sources are parallel to the long side surface of the light emitting plate and disposed with an equal interval therebetween.

13. The liquid crystal alignment device according to claim 12, wherein a rotating device is disposed between the reflective plate and the light emitting plate, and the reflective plate and the light emitting plate are rotatably connected by the rotating device.

14. The liquid crystal alignment device according to claim 13, wherein the rotating device comprises a first rotating shaft and a first rotating drum, and the first rotating shaft is firmly disposed on the light emitting plate, the first rotating drum is firmly disposed on the reflective plate; wherein the first rotating drum is a hollowed structure and the first rotating shaft penetrates through the first rotating drum, the reflective plate is rotatable with respect to the light emitting plate.

15. The liquid crystal alignment device according to claim 14, wherein the reflective plate comprises a first reflective plate and a second reflective plate, and a rolling device is disposed between the first reflective plate and the second reflective plate, the first reflective plate and the second reflective plate of each of the reflective plate are rotatably connected by the rolling device.

16. The liquid crystal alignment device according to claim 15, wherein the rolling device comprises a second rotating shaft and a second rotating drum, and the second rotating shaft is disposed on the first reflective plate and the second rotating drum is disposed on the second reflective plate, wherein the second rotating drum is a hollowed structure and the second rotating shaft penetrates through the second rotating drum, so that the first reflective plate is rotatable with respect to the second reflective plate.

17. The liquid crystal alignment device according to claim 15, wherein the reflective plate comprises a long reflective plate connected to the long side surface of the light emitting plate and a short reflective plate connected to the short side surface of the light emitting plate, and the rotating device comprises a first rotating device and a second rotating device; the long reflective plate is connected to the light emitting plate by the first rotating device and the short reflective plate is connected to the light emitting plate by the second rotating device.

18. The liquid crystal alignment device according to claim 17, wherein the long reflective plate comprises a first long reflective plate connected to the light emitting plate and second long reflective plate connected to the first long reflective plate; the rolling device comprises a first rolling device, and the first long reflective plate and the second reflective plate are rotatably connected by the first rolling device.

19. The liquid crystal alignment device according to claim 17, wherein the short reflective plate comprises a first short reflective plate connected to the light emitting plate and a second short reflective plate connected to the first short reflective plate, and the rolling device further comprises a second rolling device; the first short reflective plate is rotatably connected to the second short reflective plate by the second rolling device.
